(19) United States
(12) Patent Application Publication
(10) Pub. No.: US 2003/0014659 A1
(43) Pub. Date: Jan. 16, 2003

(54) Personalized filter for Web browsing

(75) Inventor: Liang Zhu, Palo Alto, CA (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/906,870

(22) Filed: Jul. 16, 2001

(51) Int. Cl. G06F 11/30

(52) U.S. Cl. 713/200

(57) ABSTRACT

A system, method, and article of manufacture suitable for user configurable management of accessing content provided by a provider of content (14) is disclosed, comprising providing a user who has predetermined management rights with a choice of one or more link filters, the link filters comprising permissions for functions that allow access to or transform or interpret content transferred from a source of content (14) for a browser; defining a set of user permissions which allow the user to define relationships between the content and the user such as associating the defined set of user permissions with one or more link filters and associating the defined set of user permissions with its associated link filters with the user; and storing the defined set of user permissions with its associated link filters in a persistent data store (30) wherein a desired set of user permissions may be selectively retrieved from the persistent data store (30) based on its associated user. The present invention allows use of a user created or externally supplied rating system, and further allows defining more than one link filter per URL, by way of example and not limitation such as allowing range of days, times, or a combination of these during which the link filters are operational and a similar range when the link filters are not operational. In a preferred embodiment, the present invention comprises an http proxy (20) to implement the link filtering.

### BACKGROUND OF THE INVENTION

1. Field of the Invention

The present invention relates to the field of selectively filtering content for viewing. In particular, the present invention relates to configurably tailoring a content viewer. More specifically, the present invention, in an exemplary embodiment, relates to a configurable proxy such as a proxy server operatively interfaced to a Web browser that allows individuals to configurably tailor links to content for exclusion from or inclusion for viewing. More specifically still, the present invention, in an exemplary embodiment, relates to a configurable proxy operatively interfaced to a Web browser that allows individuals to configurably tailor links to content for exclusion from or inclusion for viewing where any link can have a plurality of filters based on time of day, day of week, or a combination thereof and any link can further be associated with users on a user by user basis.

2. Description of the Related Art

Prior art web browsers offer a degree of filtering functionality. For example, the Internet Explorer™ from Microsoft Corp. of Seattle, Washington, allows a user to filter content based on ratings such as those provided by the Recreational Software Advisory Council (RSACi). RSACi has four predetermined categories of content, each category having a plurality of sub-levels by which a site's content can be rated.

The Internet Content Rating Association (“ICRA”) is a further example of a rating service. It is a voluntary service in which web authors fill out and provide responses to an ICRA questionnaire describing the web author's web content. Another filtering method is the Platform for Internet Content Selection (“PICS”).

Services such as RSACi are fixed in their configurations and are difficult to add to. For example, most of the ratings services are aimed at sites having objectionable violence, language, nudity, and/or sexual content. This does not allow a user to limit or deny access to sites that are only temporarily objectionable, such as an auction site.

Additionally, a problem with prior art filtering systems exists because there is no way to reliably determine if the labels associated with a site by the rating system adequately or accurately identify the content so labeled. Further, the adequacy or accuracy of the content labels often depends on the exact service used as well as the system employing the filter.

Additionally, an Internet Explorer™ user can add universal resource locators (“URLs”) to one of two “zones” to effect link filtering, but all URLs added to a zone will use that zone's security settings.

Some Internet users use a gateway to access the Internet. The gateway is typically a proxy server that sits intermediate the users and the Internet or another data network, such as on a local area network. U.S. Pat. No. 6,182,141, issued to Blum et al for “Transparent Proxy Server” is an example of such a proxy server. WinProxy™ by Ositis Software of 6120 Stoneridge Mall Road, Suite 210, Pleasanton, Calif. 94588 is another example of such a gateway. As with some other prior art gateways, WinProxy allows users to set up link filtering through several methods such as a third party such as SmartFilter, blacklisted URLs which are always excluded, and/or white-listed URLs which are the only sites to which access is permitted. Additionally, WinProxy allows restriction of users by time of day on a user by user or all user basis but in doing so restricts access to the entire Internet by time of day on a user by user or all user basis. WinProxy does not have the ability to restrict a user's access to one or more specific Internet sites by time of day on a URL by URL or user by user basis.

The prior art link filtering configurations take an “all or nothing” approach, e.g., the link filtering applies to all users or no users and applies all the time or none of the time. U.S. Pat. No. 5,987,606 issued to Cirasole for a “Method and System for Content Filtering Information Retrieved From An Internet Computer Network” is illustrative. There is no teaching or suggestion in the prior art to allow each user to tailor exclusions and preferences based on user-defined criteria, including allowing a user to have time of day and/or day-by-day preferences which can apply to the same link and/or content, e.g., allowing a link during a portion of the day and disallowing the same link at other portions of the day. Cirasole '606 teaches away from an individualized, single-user configurable filtering scheme.

Accordingly, the prior art does not provide a user with a flexible, self-administered filtering scheme. Although some prior art, such as Cirasole '606, suggests individualizable accounts, the prior art does not teach allowing a user to further individualize their own filtering scheme. For example, a user may wish to block certain URLs but only during working hours, allowing access to those same URLs after working hours. Additionally, a user may want to restrict access to certain URLs during all hours Monday through Friday but allow access to those URLs for limited or unlimited times on weekends.

### BRIEF DESCRIPTION OF THE DRAWINGS

The present invention is discussed below in further detail, by way of example and with reference to the accompanying drawing, wherein:

FIG. 1 is block diagram of a system in the invention; and

FIGS. 2 and 3 are flowcharts of aspects of the invention.

### DETAILED DESCRIPTION OF THE PREFERRED EMBODIMENT

In general, throughout this description, if an item is described as implemented in software, it can equally well be implemented as hardware.

The invention relates to filter software for use with a browser. A browser enables to navigate among electronic content information, e.g., Web sites, that are available on a data network such as the Internet. In the invention, the filter software selectively enables or disables access to specific content information (e.g., Web sites that have certain attributes: Web sites of specific semantic content; Web sites of a specific category according to a pre-specified index; Web sites that enable downloads of executables or of copyrighted information, etc.) depending on, or under control of, a temporal aspect of the use of the browser. The temporal aspect relates to, e.g., a timeslot in a day or per day, the day of the week, a frequency of browser use per time slot, a frequency of accessing specific content per timeslot, never, etc. Accordingly, the invention implements per individual user of the browser a filter to controllably allow or deny access to specific content while taking into account a temporal aspect of the browsing. The filter may selectively enable or disable the access based on an identity of the user. The filtering operation may take further criteria into account to determine the disabling or enabling, e.g., bandwidth requirements, local data traffic, etc.

The filter may be configurable by the user or by another party, e.g., the service provider, the user's employer (when the user is browsing using company's equipment) or the user's parent. In the latter case, access to the filter may be (e.g., password-) protected to enable only authorized parties to configure the filter.

The filter may be installed at the end-user's data processing equipment (desktop PC, set top box, laptop PC, or another electronic device) e.g., as a plug-in of the browser software or as an integral part of the browser. Alternatively, the filter is installed at a server (e.g., gateway or proxy) of the service provider. As yet another example, part of the filter may reside at the end-user's equipment, and another part at the service provider's server.

When installed at a server, or at the end-user's data processing equipment with third-party controlled password authorization to configure the filter, the service provider or the other party is enabled to control access to electronic content available on a data network through the browser. The access control selectively enables or disables access to specific electronic content information dependent on a temporal aspect of the use of the browser. For example, certain sites may attract substantially more traffic at certain times than do other sites. By involving the temporal aspect of browser usage, the service provider or network operator can affect the network load by charging the individual user an increased fee dependent on the time of the day or the frequency of access. On the other hand, the access criteria may be specified by the user or by the person whose account is going to be charged for the data services. In this manner, the user is less tempted or is even discouraged or disabled to access specific web sites when it is not appropriate to do so according to the opinion of whomever personalized the filter.

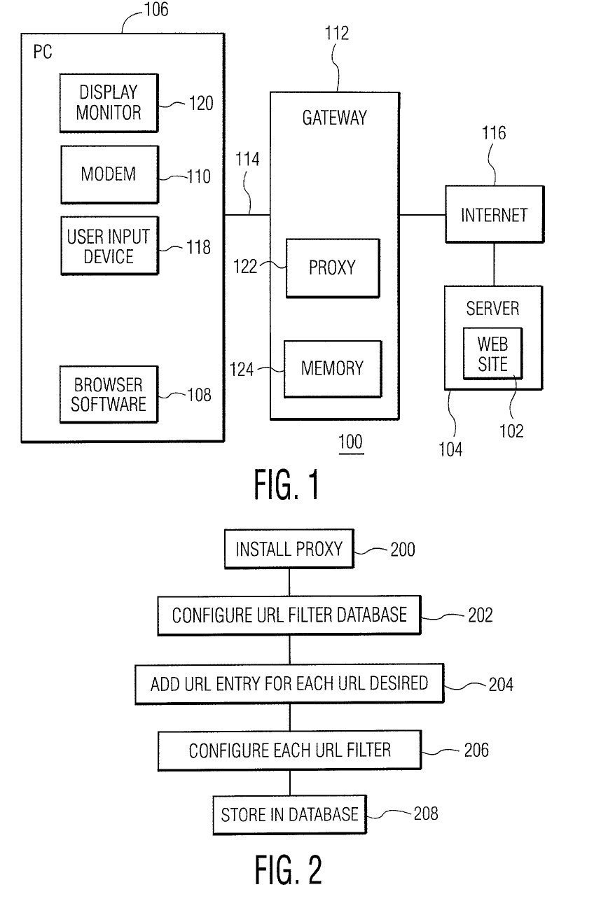

Referring now to FIG. 1, a typical Internet browser system 100 comprises a source of content such as Internet web site 102 residing on a server 104 (116), a computer 106 (10) with a browser 108 (11), Computer 106 has a a modem 110 to connect to a gateway 112 of an Internet Service Provider (ISP) via telephone link 114. ISP 112 enables the user to get onto the Internet 116 and access Web site 102 Computer 106 is typically a personal computer as will be familiar to those of ordinary skill in the computer arts, comprising, in addition to modem 110, an input device 118 , and a display monitor 120. As will also be familiar to those of ordinary skill in the computer arts, computer 106 can also be a personal digital assistant such as a Palm manufactured by Palm Inc. of Santa Clara, California; an Internet web device such as the Net Display Module from Royal Philips Electronics; a mobile phone with web browsing capability; or the like.

Browser software 108, executable within computer 106, typically comprises a method by which an http address is translated for use with the Internet 116. As will be familiar to those of ordinary skill in the Internet arts, a user can enter, via input device 118, a URL such as a text string “90.0.0.1” or the URL name such as a text string “www.philips.com”, which is then translated into the four octet URL header required by the protocol of the Internet 116. Additionally, software executing with the browser 108, either as an applet or as part of the browser itself, can generate a request for URL, e.g. through a hyperlink on a page of displayed content.

System 100 further comprises an http proxy server 122. Proxy 122 is, for example, integratable with browser 108 such as with a plug-in as that term will be familiar to those of ordinary skill in the browser software arts. As used herein, http proxy 122 may be implemented in numerous functionally equivalent ways as will be readily apparent to those of ordinary skill in the Internet software arts. Thus, http proxy 122 comprises hardware and/or software cooperatively in communication with browser 108, and may include a separate program executing locally within the same computer 106 as browser 108, as a portion of another program executing in gateway_122, as a separate program executing locally on the same computer as gateway 112, or the like, or a combination thereof. By way of further example and not limitation, http proxy 122 may be a service offered by an online service provider that offers each user storage and access to their own URL filtering database. In another embodiment, http proxy 122 may be a service offered by online service provider of gateway 112 that uses a URL filtering database to filter Internet actions, such as through search engines such as the PlanetSearch service of Philips Electronics at www.planetsearch.com whose search engine is described by U.S. Pat. No. 5,293,552, home pages, or through other Internet service providers.

Proxy server 122 intercepts each request from the user of PC 106 for a URL and checks it against a URL filtering database or other file containing a set of URLs associated with a user and stored on persistent data store 124. As will be familiar to those of ordinary skill in the programming arts, the URL filtering database can be individualized to each user such as by having a separate filtering database for each user or by having a field in each record of the filtering database to identify the user with which that record is associated.

One or more functional interfaces to http proxy 122 allow a user to uniquely define, create, and maintain their URL filtering links. Additionally, in an alternative embodiment, a managing user having predetermined management rights can selectively configure system 100 to allow or disallow such user functions on a user-by-user basis, a group basis, or any other basis as will be familiar to those of ordinary skill in the programming arts. Further, http proxy 122 can dynamically create entries in the URL filtering database such as by detecting a new URL, causing a pop-up to appear or other applet to execute at browser 108, and requesting directives from the browser user such as filtering directives or save/discard directives.

In the operation of an exemplary embodiment, in general, before a user begins accessing and browsing the Internet, the user logs on, allowing proxy 122 to determine the identity of the user. Users who do not have logon rights are rejected by proxy 122 as are requests made by users and/or processes that have not logged on properly. Once logged on, proxy 122 retrieves a set of filters associated with that specific user from the database. From that point until the user logs off, proxy 122 checks each requested URL against the filters and takes appropriate actions based on the user's filters.

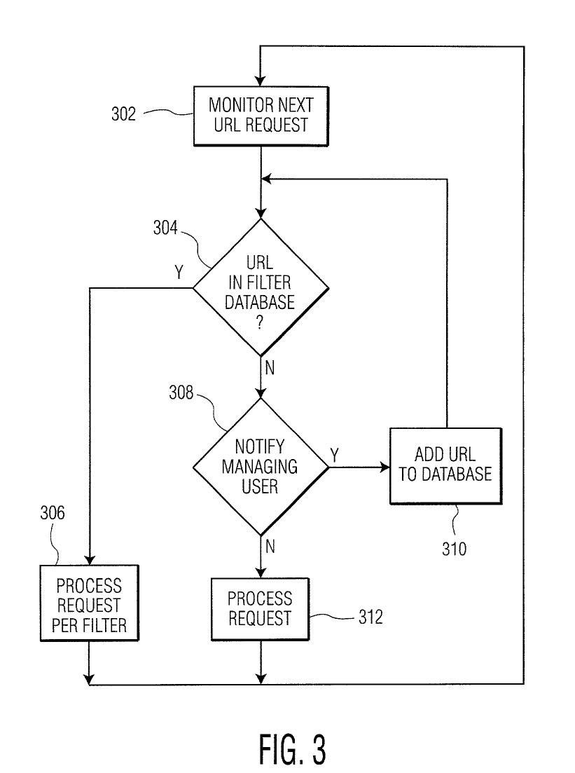

Referring now to FIG. 2, a managing party or managing user of PC 106 with predetermined management rights installs, at step 200, http proxy 122 of the current invention. In embodiments of the invention, proxy 122 can be installed as a proxy server local to computer 106 or can be integrated with another proxy server such as over local area network 114 to gateway 112.

The managing party then configures, at step 202, http proxy 122 according to one or more managing user selected criteria. These allow a URL request to be permitted or denied when requested by a given user based on the criteria for that specific URL and that specific user. As opposed to the prior art, the managing party can add, modify, or delete entries in each users' set of URL permissions 204, 206 by tailoring these URL permissions to several user-defined categories. The categories can not only encompass “labels,” e.g. “violence” or “language,” but can also be tailored to indicate other preferences such as time of day or day of week or a combination thereof. In this manner, each URL in the URL filtering database can better reflect a user's experiences and needs. By way of example and not limitation, a user may decide that access to “www.xyz.com” is distracting between 8:00 a.m. and 6:00 p.m. each day but desirable after 6:00 p.m.. By way of further example and not limitation, a user may decide that access to “www.xyz.com” is distracting to and inappropriate for school age browser users Sunday through Thursday all day but acceptable between 5:00 p.m. and 7:00 p.m. on Saturdays.

Although a managing user may use rating systems such as RSACi, the present invention further allows a managing user to create a rating system unique to the system as a whole or to each user. By way of example and not limitation, a managing user may create a particular rating category “A” that, in the managing user's opinion, is appropriate for a 12 year old child but is not appropriate for a 3 year old child.

The managing user can additionally select from a predetermined set of link filters to be associated with each URL in the URL filtering database on a per user basis. As used herein, “link filters” comprise permissions for functions that either allow access to a source of content such as the gateway 112 of online service provider and associated servers (not shown) and/or transform or interpret data transferred from the source of content 102 for a browser. By way of example and not limitation, a link filter may be defined to allow selective access to content at a URL while denying access to other content at that same URL, to completely deny access to the URL, to allow certain functions to occur at a URL such as JAVA® applets but disallow other functions such as ftp or a file with an “.exe”-extension or the like, or a combination thereof.

In a currently envisioned alternative, two sets of filters may exist. Global filters are those which apply to all users. Local filters are specific to each individual user. In this manner, a default set of filters may be applied, such as to a “guest” user or other users without user preference settings. Also, the user of PC 106 may him/herself define the filtering capabilities and have them uploaded to proxy 112 for storage in memory 124. The ISP may provide access to different packages of content at different prices. A particular package may be characterized by a quality of service (e.g., color vs. black/white, or higher resolution vs. lower resolution), access to specific semantic content or to Web sites that ordinarily attract high traffic. The user's filtering criteria can then be used to tailor an access package for this specific user. The filtering or the layered access is then a tool for the ISP in order to control, at least to some extent, the data traffic to and from the terminals of the subscribers. For example, some Web sites may be highly popular to the subscribers during certain times of the day, and may be hardly visited during other times. The ISP can therefore offer access to Web sites based on filtering criteria that are applicable during specific hours of the day for a lower fee if the access is desired during time slots that normally have light data traffic. Accordingly, in a more general sense, the invention provides a method of providing a service on a data network. The method comprises enabling to browse electronic content on the network under control of a filter that is configurable per user; and offering respective configuration options for the filter for selectively disabling or enabling access to the content in respective scenarios.

When completed the managing user will have defined a set of user permissions for each browser user for which filtering is desired. This set of user permissions define relationships between content at a URL and each browser user on a user by user basis. The set of user permissions, including its associated link filters, is then stored in step 208 on persistent data store 124 for selective retrieval on a user-by-user basis by the http proxy server 122.

Referring now to FIG. 3, as each URL is requested at a browser, proxy 122 monitors in step 302 the requested URL and retrieves in step 304 the set of preferences for the browser user associated with the requested URL, if any. If an entry in the URL filtering database is found that corresponds to the requested URL, proxy 122 processes in step 306 the request according to the retrieved set of preferences, e.g., blocks the request.

The managing user can add new sites to the URL filtering database as those new sites become known to the managing user or http proxy .122 By way of example and not limitation, when a browser user bookmarks a web site not already in the URL filtering database of memory 124 or when proxy server 122 detects such a URL such as at step 304, proxy 122 can notify in step 308 the managing user such as by displaying a pop-up or other dialog box as will be familiar to those of ordinary skill in the software programming arts to request the user or a managing user that the URL be added to the URL filtering database at step 310 along with its appropriate filtering preferences, or to notify the user or managing user that the URL has been added to the database based on, e.g., its probable semantic category. If the user or managing user is not notified, the request is processed in step 312.

In an additional embodiment currently envisioned, proxy 122 can programmatically modify the URL filtering database. In a presently envisioned embodiment, proxy 122 can use heuristics or other rules-based decision methods as will be familiar to those of ordinary skill in the software arts to increase the relevance of search engine results or other link retrievals. By way of example and not limitation, proxy 122 can create and/or modify entries in the URL filtering database using the user's actual, browsing history such that search request results or other links are congruent with the user's other URL link filtering patterns.

As will be understood by those of ordinary skill in the software programming arts, the present invention's managing user can be the same user as the browser user. In this way, a user may have access to and complete control over a self-initiated web browsing filter.

The present invention provides a user with a flexible method of providing URL filtering. By way of example and not limitation, a user can opt to configure the user's URL filtering database to deny access to the first site, “www.first.com,” between 10:00 a.m. and 5:00 p.m. each weekday. Further the user can opt to configure the user's URL filtering database to only allow access to the second site, “www.second.com,” between 1:00 p.m. and 1:30 p.m. each day.

In addition, a user can define category entries instead of URL entries. For example, the user has defined two categories, “news” and “entertainment” and has also defined “www.first.com” as being in the “news” category and “www.second.com” as being in the “entertainment” category. Access to all “news” category URLs will be denied between 10:00 am and 5:00 p.m. each weekday.

It will be understood that various changes in the details, materials, and arrangements of the parts which have been described and illustrated above in order to explain the nature of this invention may be made by those skilled in the art without departing from the principle and scope of the invention as recited in the following claims.

What claimed is:

1. For use with browser software that enables to navigate among electronic content information available on a data network: filter software for selectively enabling or disabling access to specific electronic content information depending on a temporal aspect of using the browser software.

2. The filter software of claim 1, wherein the filter software selectively enables or disables access dependent on an identity of a user of the browser software.

3. The filter software of claim 1, wherein the filter software selectively enables or disables access based on at least one predetermined criterion.

4. The filter software of claim 3, wherein the filter software is configurable by an end-user of the filter.

5. The filter software of claim 1, for selectively enabling or disabling access to respective specific content information depending on respective attributes of the respective information.

6. The filter software of claim 1, wherein the temporal aspect represents at least one of the following: a time slot in a day; a day of a week; a frequency of use per pre-determined time slot; and a frequency of accessing the specific content per predetermined time slot.

7. The filter software of claim 1, for being installed on data processing equipment of an end-user.

8. The filter software of claim 1, for being installed on a proxy server.

9. The filter software of claim 1 combined with the browser software.

10. An electronic device comprising:
filter software for selectively enabling or disabling access to specific electronic content information available on a data network through browser software depending on a temporal aspect of using the browser software.

11. The device of claim 10, wherein the filter software selectively enables or disables access dependent on an identity of a user.

12. The device of claim 10, wherein the filter software is configurable by a user.

13. A method of enabling to control access to electronic content information available on a data network through a browser, the method comprising providing a filter for selectively enabling or disabling access to specific electronic content information depending on a temporal aspect of use of the browsing.

14. The method of claim 13, wherein the filter selectively enables or disables the access based on an identity of a user doing the browsing.

15. The method of claim 13, comprising selectively enabling or disabling access to respective specific content information depending on respective attributes of the respective information.

16. The method of claim 13, wherein the temporal aspect represents at least one of the following:
a time slot in a day;
a day of a week;
a frequency of use per pre-determined time slot; and
a frequency of accessing the specific content per predetermined time slot.

17. The method of claim 13, wherein the filter is configurable by a service provider.

18. The method of claim 14, wherein the filter is configurable by a software provider based on a specification provided in advance by a user.

19. A method of providing a service on a data network; the method comprising:
enabling to browse electronic content on the network under control of a filter that is configurable per user; and
offering respective configuration options for the filter for selectively disabling or enabling access to the content in respective scenarios for a respective fee.

20. The method of claim 19, wherein the selective enabling or disabling is determined by a temporal aspect of the browsing.
